(19) United States
(12) Patent Application Publication
(10) Pub. No.: US 2014/0032278 A1
(43) Pub. Date: Jan. 30, 2014

(54) METHOD AND SYSTEM FOR EMPLOYEE PERFORMANCE EVALUATION AND MONITORING

(71) Applicants: Anand Deshpande, Pune (IN); Siddhesh Bhobe, Pune (IN); Vinod Unni, Pune (IN); Manish Mahajan, Pune (IN); Harsha Kumar, Pune (IN); Amruta Pawar, Pune (IN); Anshul Bhamore, Pune (IN); Prajakta Chavan, Pune (IN); Kedar Bindu, Pune (IN); Ashish Salokhe, Pune (IN); Shridhar Kurhade, Pune (IN)

(72) Inventors: Anand Deshpande, Pune (IN); Siddhesh Bhobe, Pune (IN); Vinod Unni, Pune (IN); Manish Mahajan, Pune (IN); Harsha Kumar, Pune (IN); Amruta Pawar, Pune (IN); Anshul Bhamore, Pune (IN); Prajakta Chavan, Pune (IN); Kedar Bindu, Pune (IN); Ashish Salokhe, Pune (IN); Shridhar Kurhade, Pune (IN)

(73) Assignee: PERSISTENT SYSTEMS LIMITED

(21) Appl. No.: 14/112,418

(22) PCT Filed: Apr. 20, 2012
(86) PCT No.: PCT/IN12/00286

§ 371 Date: Oct. 17, 2013

(30) Foreign Application Priority Data
Apr. 20, 2011 (IN) 1270/MUM/2011

(51) Int. Cl. G06Q 10/06

(52) U.S. Cl. CPC G06Q 10/06393
USPC 705/7.39

(57) ABSTRACT

The present invention provides a method and system for employee performance evaluation and monitoring. The method and system eliminates the need to follow the legacy performance review process. The method and system makes it easy for the employee to get timely/continuous inputs for self improvement. Further, the method and system also eliminates the need of complex and lengthy performance evaluation process at the time of appraisals as the calculated worth or value of employee is available at any given point of time for bonus and rewards/recognition. This also eases up the process of comparing performance of team members as the aggregate calculated value or worth can be uniformly used for comparison which is not possible in case of only textual performance notes.

### FIELD OF THE INVENTION

The invention relates generally to the field of employee performance evaluation and monitoring system, and more particularly to, a method and system wherein, the employee's performance calculation is primarily driven by linkage of each performance note with a unit value that can be construed as the employee's value or worth in terms of performance at any point of the year. The invention also relates to a method to increase employee senior employee interaction through virtual reality and using enterprise social networking for discovering employee skills and expertise in a given organization. The invention further relates to a method to allow employees to get recognized for performance through virtual gift requests.

### BACKGROUND OF THE INVENTION

In today's business climate, for organizations whose business is directly linked with the people and their skills/quality of work, it is now more important than ever to maintain a close relationship with employees. As costs to acquire new employee increases, and taking into account the cost of training programs, grooming employees for building competencies in new areas your customers are interested in, each employee quitting the company increases the overall operational cost and generating higher revenue from your employee base becomes an essential requirement to survival.

One way of retaining the employee base and encouraging/motivating them is to establish a platform for continuous feedback evaluation and rewards/recognition. There are studies showing that employees find the process of appraisal more satisfying and credible when it is directly linked to reward outcomes. An employee bonus—whether it's cash, or a gift, or time off, or something else of value—is a powerful tool to motivate a workforce.

Further, in today's times, interaction between employee and senior employee happens over emails or over staid forms during appraisal time. Emails are never revisited and don't act as a reliable record of performance. Forms based applications only provide fields for which values have to be provided or ratings are given. Neither actually encourages/motivates/interests the senior employee to visit again and evaluate the performance of his sub-ordinates on a regular basis. More importantly, there are little or no avenues for employees to initiate these meetings and contacts with their senior employees.

### BRIEF DESCRIPTION OF THE DRAWINGS

The aspects and features of the invention can be better understood with reference to the drawings. The drawings are not necessarily to scale, emphasis instead generally being placed upon illustrating the principles of the invention.

FIG. 1 illustrates an user interface representing an online avatar of a profile of an employee, in accordance with the present invention;

FIG. 2 illustrates an objective setting for the employee against Key Result Area (KRA), in accordance with the present invention;

FIG. 3 illustrates setting up virtual gifts which is used as a corollary to the employee's performance, in accordance with the present invention;

FIG. 4 illustrates employee performance in the respective Key Result Area, in accordance with the present invention;

FIG. 5 illustrates continuous performance management of the employee, in accordance with the present invention;

FIG. 6 illustrates mapping of the gift request to the task given to the requestor, in accordance with the present invention;

FIGS. 7, and 8 illustrates calculating worth/value of the employee for providing the employee with virtual gifts, in accordance with the present invention;

FIG. 9 illustrates bonus calculation by converting total unit value earned by the employee into a materialized reward, in accordance with the present invention;

FIGS. 10, 11, 12, 13 shows a community center for sharing important and relevant information for employees, in accordance with the present invention; and

FIG. 14 illustrates a system for performance evaluation of employees in accordance with the present invention.

### DESCRIPTION OF THE INVENTION

The present invention is an entirely new way of doing things. From online interaction of senior employee and employee to continuous feedback mechanism, from providing gifts as formal performance feedback to requesting a gift by the employee, the present invention is a new approach to an old, dull, not interactive process. The present invention is an entirely new way of calculating performance bonus directly tied to continuous performance in a clear and transparent fashion.

The present invention eliminates the need to follow the legacy performance review process. The features of the present invention make it easy for the employee to get timely/continuous inputs for self improvement. It also eliminates the need of complex and lengthy performance evaluation process at the time of appraisals as the calculated worth or value of employee is available at any given point of time for bonus and rewards/recognition. This also eases up the process of comparing performance of team members as the aggregate calculated value or worth can be uniformly used for comparison which is not possible in case of only textual performance notes.

Online Avatar:

In accordance with the embodiment of the present invention, every employee of an organization or a company is provided with an User Interface to view and access the information. In an embodiment, the user interface is provided in a client component, such as communication device. According to the preferred embodiment of the present invention, an alternate visualizations for performance data is provided, thus providing greater appeal to the end user making day to day tasks more interesting and interactive.

In the preferred embodiment of the present invention, a User Interface is provided with look and feel varying as per Grade or Designation of the employee. In some sense, this personalized UI represent an Online “Avatar” of the profile of that employee and creates an interactive world around his performance, skills, competencies and organizational data. For this, system maintains a set of themes which are loaded on run-time after successful login.

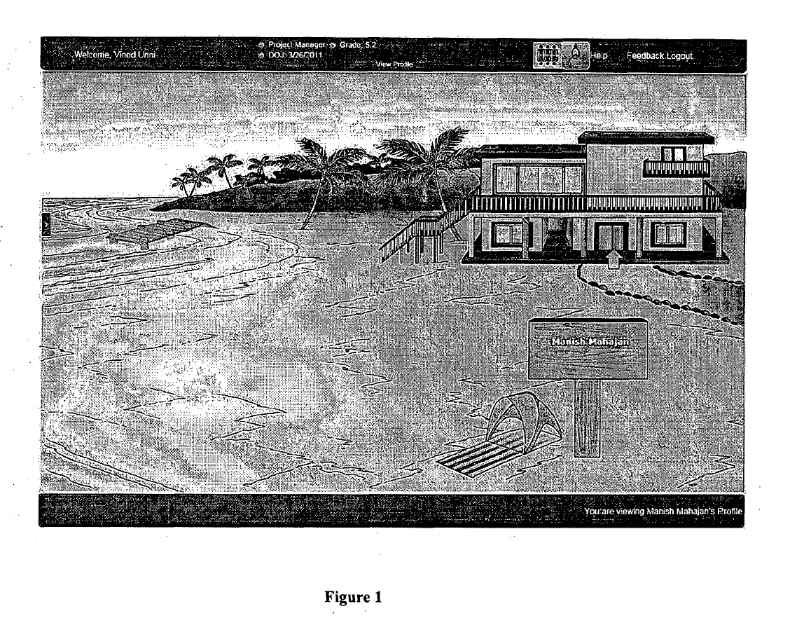

These aspects of present invention are illustrated with reference to FIG. 1.

Objective Setting:

In accordance with the present invention, at the start of an appraisal cycle, a senior employee is enabled to assign Key Result Area (KRA) to each sub-ordinate and set Objectives against each. A fixed duration of few days/weeks may be assigned to complete the activity and clear and detailed inputs on each objective are provided to the employee so that there would be no doubt/misunderstanding on what needs to be achieved. These objectives are maintained in the present invention and the same can be referred at any time by the employee, senior employee and other authorized stakeholders. The assigned KRA's are stored in a first database of a context senior employee.

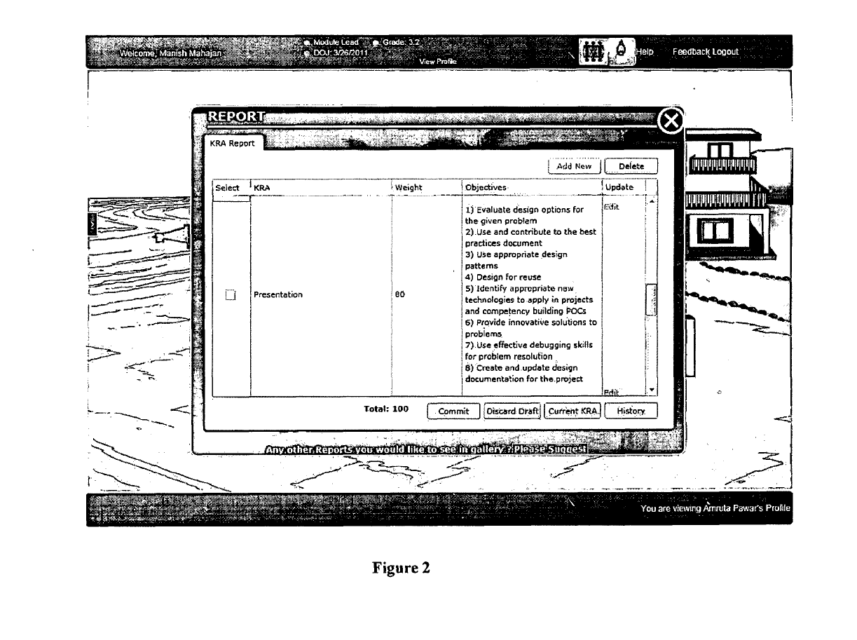

These aspects of present invention are illustrated with reference to FIG. 2.

Setting Up Virtual Gifts:

In accordance with the present invention, online virtual gifts are provided and used as a corollary to employee's performance. For this, at the start of appraisal cycle, organization are enabled to set up various categories of virtual gifts and assign a unit value to each gift category based on its importance and relevance in a server. This gift metadata and value information is stored in appropriate second database in the system provided by the present invention.

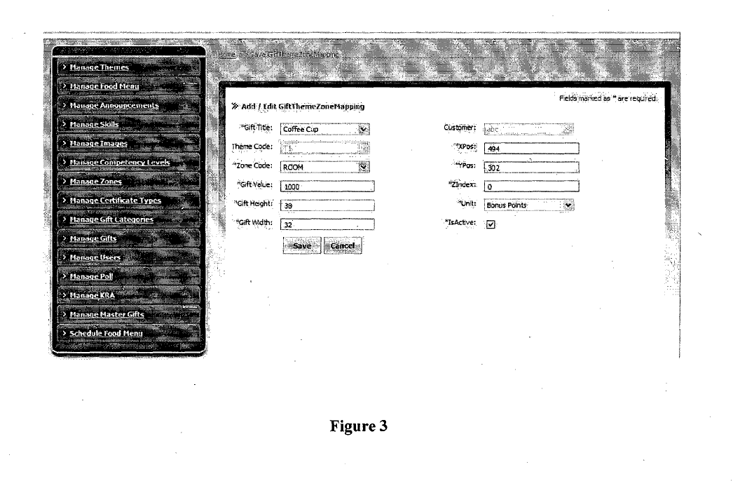

These aspects of present invention are illustrated with reference to FIG. 3.

In an embodiment of the present invention, gifts can be mapped to KRA. In yet another aspect of the present invention, a User can ask for the gift against his standard set of key result area. Employee performance in the respective KRAs can easily be visualized through the gifts he/she has for each of his KRA.

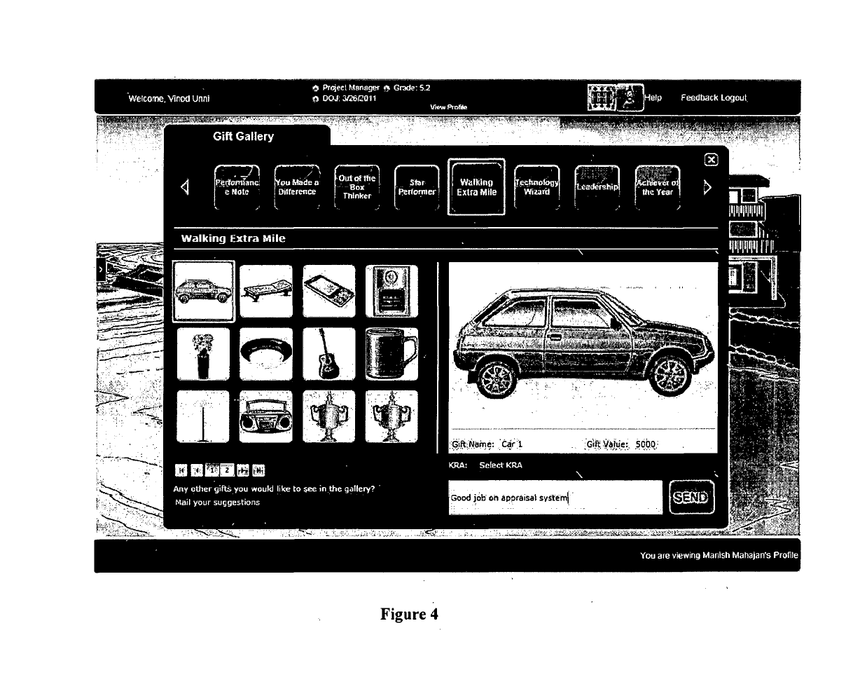

These aspects of the present invention are illustrated with reference to FIG. 4. Continuous Performance Management:

In an embodiment of the present invention, the method for that appraisal cycle is made available to all the employees for continuous performance management. The senior employee is enabled to use this system to give virtual gifts (performance notes) to any sub-ordinate

In an aspect of the present invention, not only can the senior employee provide gifts and comments to employees, but in a very unique way, the system allows employees to ask for gifts that work as a request sent by the employee to his/her senior employee for a specific virtual gift (performance note). The senior employee, in such situation, is forced to respond, either accepting the gift request and thereby recognizing the performance formally, or rejecting the request with appropriate comments through client component and the server. This activity is not bound to any specific trigger/event and employees are allowed to use this any time during the appraisal cycle whenever they feel they have performed some task/job that deserves recognition.

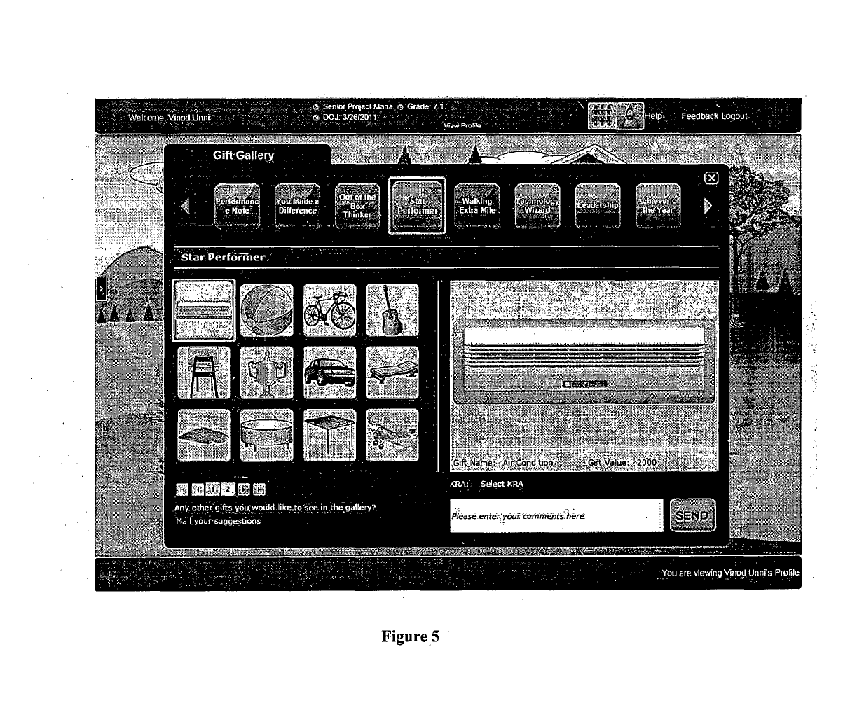

These aspects of the present invention are illustrated with reference to FIG. 5.

In accordance with the present invention, an option is provided to the user to approve, reject or hold the gift requests he/she has received.

In an embodiment of the present invention, on receiving the gift request from the subordinate or the team, the senior employee is forced to respond, either accepting the gift request and thereby recognizing the performance formally, or responding with a task or assignment that the employee needs to perform to earn that gift. After receiving the gift request from subordinate, one can reject the request if he does not agree with the performance of the requestor. In an embodiment of the present invention, the gift request can be mapped to the task, where the task will be given to the requestor and on completion of that task the gift request would be approved.

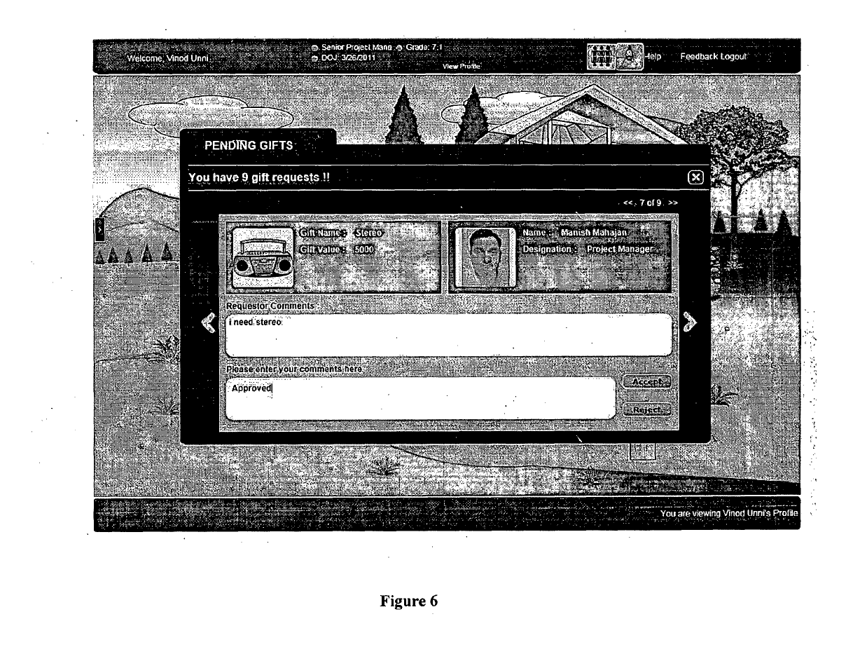

These aspects of the present invention are illustrated with reference to FIG. 6.

Calculating Worth/Value of an Employee:

In accordance with the present invention, senior employees use virtual gifts as a corollary to an employee's performance. The performance can be good, bad or neutral, indicating positive and negative gifts respectively. As each gift would have a particular unit value in the present invention, calculation of the total unit value or worth at any point of the year can be done based on gifts received and unit value of each gift, thus directly linking the worth of the employee's performance to his or her bonus. A higher value would indicate a higher bonus. Achieving this functionality of calculating bonus in a textual notes based performance management system is not only a time consuming activity but also it is difficult to do a fair evaluation and comparison of performance.

The present invention provides a continuous feedback mechanism whereby the employer can use virtual gifts as a corollary to an employee's performance.

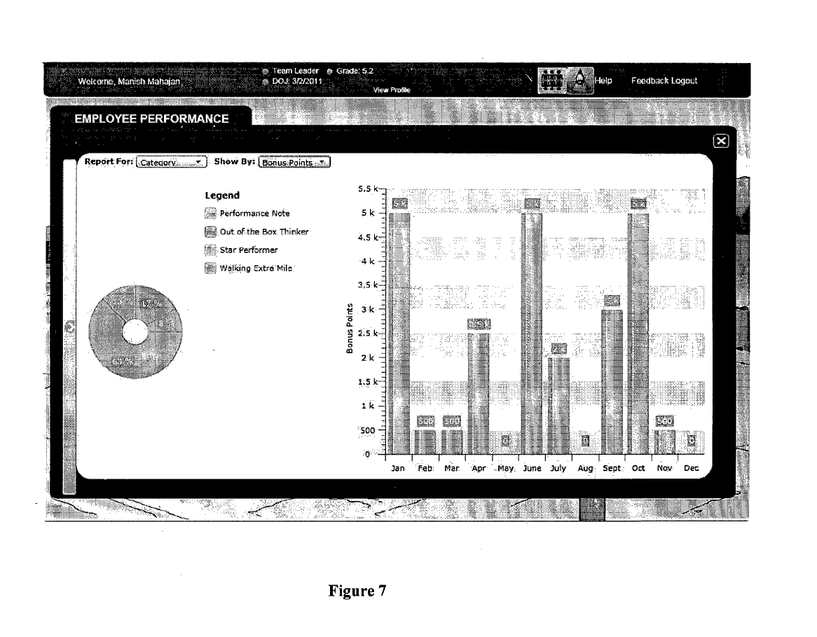

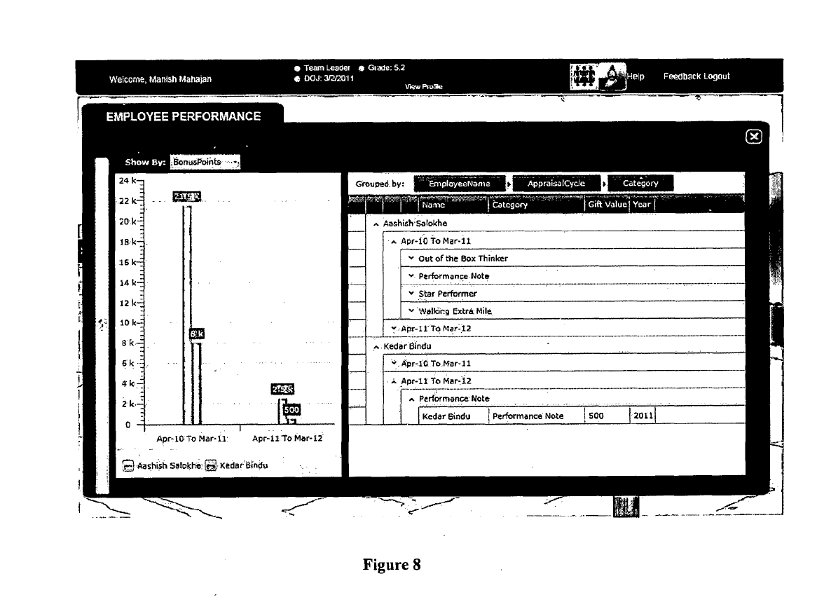

These aspects of the present invention are illustrated with reference to FIGS. 7 and 8.

Bonus Calculation:

According to an embodiment of the present invention, the organization, at the time of the Bonus calculation, may use some simple configurable pre-determined formula to convert the total unit value into a materialized reward—money, actual gifts and benefits.

The present invention eliminates the need to follow the legacy performance review process. The features of the present invention make it easy for the employee to get timely/continuous inputs for self improvement. It also eliminates the need of complex and lengthy performance evaluation process at the time of appraisals as the calculated worth or value of employee is available at any given point of time for bonus and rewards/recognition. This also eases up the process of comparing performance of team members as the aggregate calculated value or worth can be uniformly used for comparison which is not possible in case of only textual performance notes.

Gurukul:

In an another aspect of the present invention, employees are allowed to have their own world of showcasing their technical skill level/competencies. Every employee can be given a Graphical User Interface called as “Gurukul” in the communication device. This world may comprise:
A Guru/Guru Ma—an avatar of an employee's technical profile—and his followers i.e. people that follow that employees for help/knowledge sharing/mentoring on specific skills, etc.
Book Shelf with number of books representing top 3 skills of that employee with competency level
Certifications/exams that employee has cleared. In an embodiment of the present invention, this can be represented as awards/trophies in the “Gurukul.”

In yet another aspect of the present invention, the User can also add “followers”—a feature that allows visitors an ability to follow a “Guru/Guru Ma.”

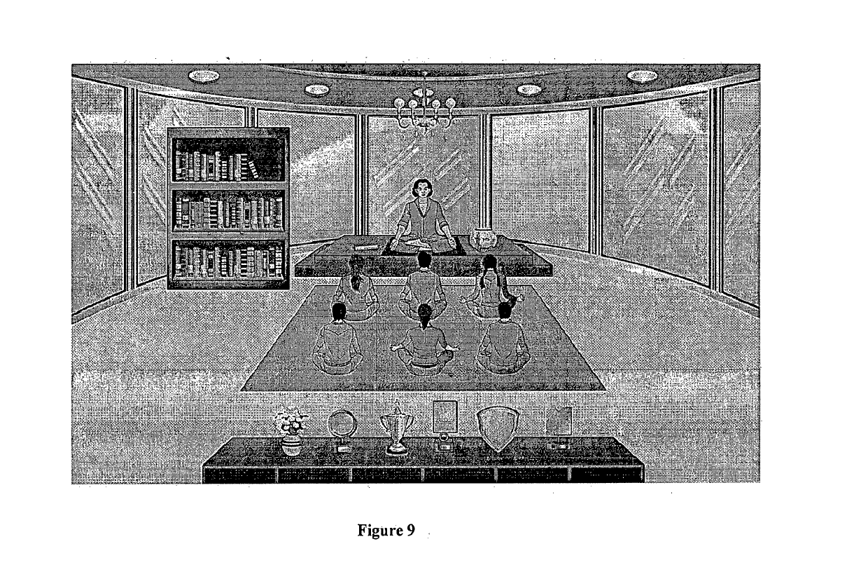

These aspects of the present invention are illustrated with reference to FIG. 9

Community Center:

In an embodiment of the present invention, a Community Center is also provided for. The present invention allows organizations to set up a mini intranet called as “Community Center” for employees to share important and relevant information for employees. This is represented as a Stadium and the UI provides a quick view of, inter alia, following data:
Restaurant—Provides quick and interesting view of Food Menu for the day.
Employee of the Day—An animation based UI showing details of Employee of the Day. In accordance with the invention, an Employee could be selected as “Employee of the Day” based on value/worth of his Gifts for that appraisal cycle/period.
Announcements—A TV screen in the stadium to show either videos or textual announcements made by the Company.
Birthdays and Anniversaries—A UI to show employees sharing their Birthdays and Anniversaries on that day.

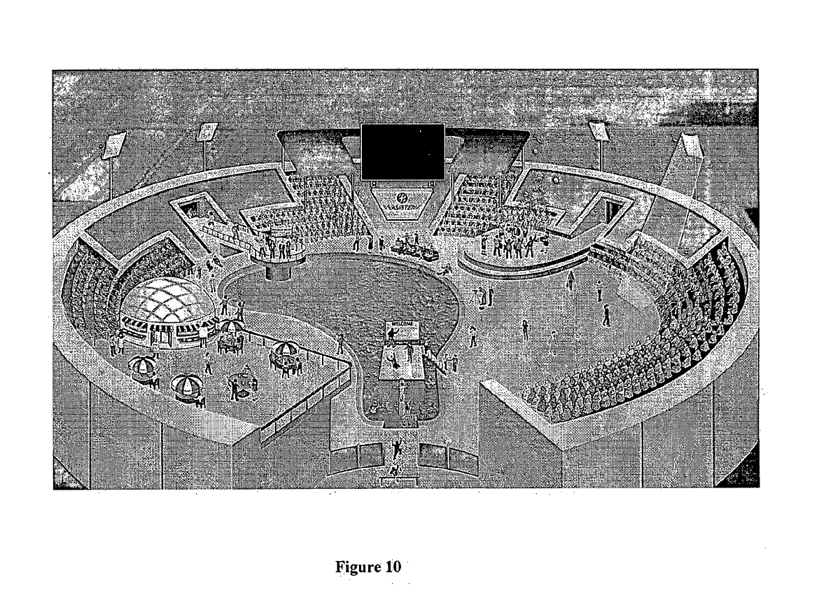

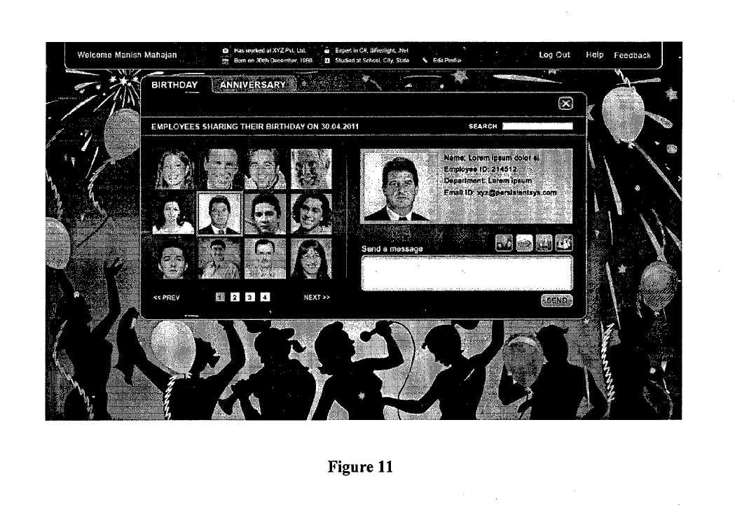

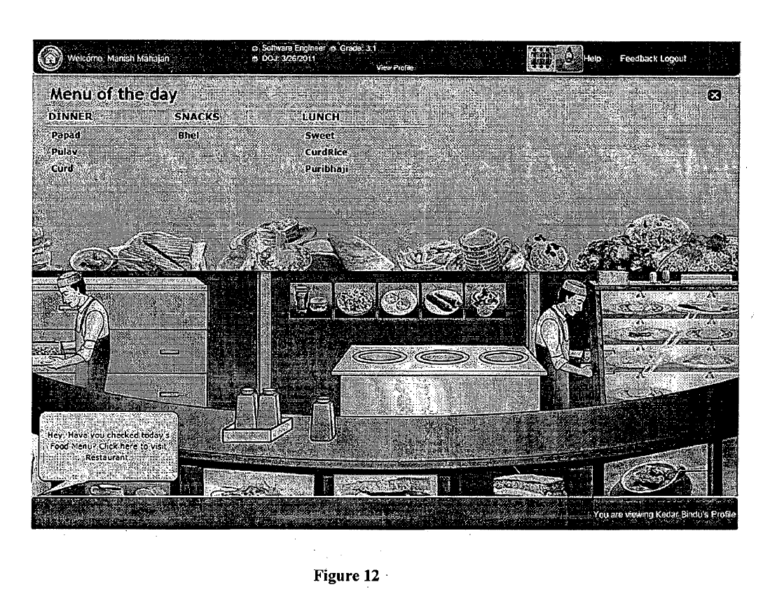

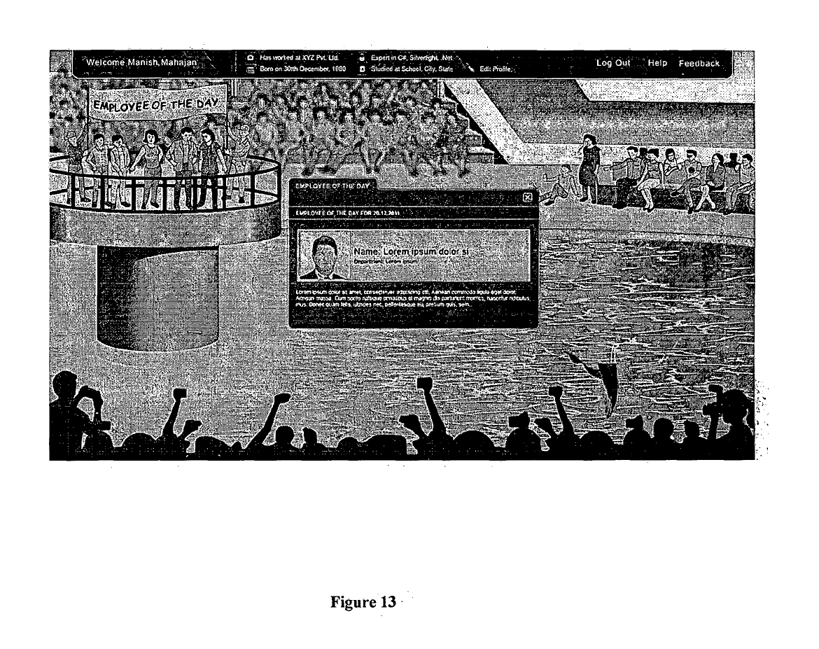

These aspects of the present invention are illustrated with reference to FIGS. 10, 11, 12, and 13.

System:

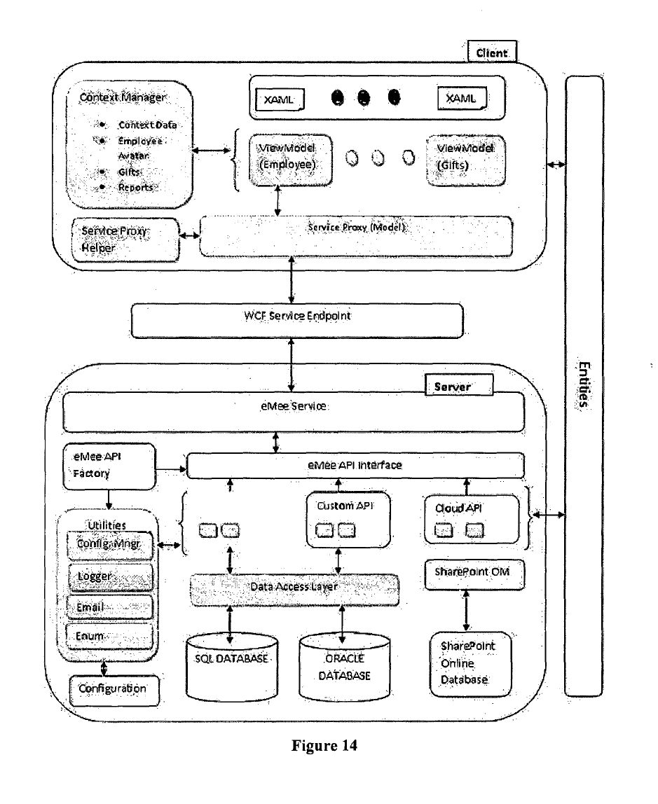

A system for performance evaluation of employees in accordance with the present invention is illustrated with reference to FIG. 14.

The system includes different components of the application—Client, Server and Entities, etc. In accordance with the present invention, the Client communicates with the Server using WCF services. The Entities component is used at both the Client and Server side. The Client populates the Entities with the required data and then sends it as Data contract to the Server.

Client:

In accordance with an embodiment of the present invention, the Client component is a communication device having Views (XAML pages), ViewModels, ContextSenior employee class, and Service Proxy Helper class. The UI follows the MVVM pattern in which the view model provides a data model and behavior to the view but allows the view to declaratively bind to the view model. The view becomes a mix of XAML and C#, the model represents the data available to the application, and the view model prepares the model in order to bind it to the view.

Context Senior Employee:

In accordance with the present invention, the ContextSenior employee maintains the current context of the application. This class comprises data, inter alia, about the Logged-in user, Current context user, List of Gifts, etc. This data gets populated through the ServiceProxyHelper class. The Context data can be shared across the different Views of the application and the Views can subscribe to the Change event of the Context data. Every time there is a change in the context data it will update the context & the context will in turn notify to all the subscribers which are interested to listen to the changes.

ServiceProxyHelper:

The ServiceProxyHelper facilitates communication between the UI and the Service (WCF) class. This class implements the Singleton pattern hence ensuring that only one instance of the object is available throughout the application. According to the present invention, all calls to the WCF methods are forwarded through the ServiceProxyHelper class.

Server:

According to the present invention, the Server component comprises of WCF services, API Factory class, Utilities, and Data Access Layer (DAL). The Client component interacts with the Server component using WCF service contracts. The WCF Service then calls the required API interface to query the database.

API Factory:

In accordance with the present invention, this class implements the Factory pattern to create a concrete objects of the ProductAPI, CustomAPI or CloudAPI class, based on the input parameter passed to the APIFactory's Create API( ) method. It exposes an interface—eMee API Interface (IAPI) that contains functions to get the data from Product, Custom, or Cloud database respectively.

Utilities:

In accordance with the present invention, this block comprises all miscellaneous functionality that would be required to support the application.

Logger.

In accordance with the present invention, this class would provide one-stop solution for Message Logging Management. It would take care of, inter alia, the following
Logging exceptions
Logging debug messages
Logging warning messages
Logging miscellaneous information
Options to logging to a file/database/Event log depending on application need.

Configuration Senior Employee:

In accordance with the present invention, a Configuration Senior employee is provided that comprises functions that read the application settings. This can be used both by the Client and Server to fetch the application settings from App.config or Web.config file.

Enum:

In accordance with the present invention, the Server class also comprises of Enums and Constants required throughout the application both on Client and Service side.

Data Access Layer (DAL):

According to the present invention, this block comprises generic methods for accessing the database and returning common objects like DataTable (Table), DataSet (Collection of Tables), Boolean for query execution success/failure etc. It would support calling of both Stored Procedures and SQL queries.

The DAL implementation is provider independent to ensure that multi database support is provided. The DAL layer can connect to any database like SQL, Oracle, Access, etc.

Entities:

In accordance with the present invention, this block comprises all the business entities that would be used as a communication protocol between Service layer and Client layers. For example, entities like Employee, Gift, KRA, Skill etc. would be created.

Advantages of the Present Invention:

The present invention is an entirely new way of doing things. In addition to the advantages that may be apparent to a person skilled in the art, few advantages of the present invention are:
Easy and interesting method and system for employee performance review and feedback;
Employee can initiate performance evaluation and reward process. This ensures timely performance feedback for employees and areas of improvement to work on;
Introduces a continuous feedback mechanism instead of a periodic/event based activity;
Simplifies the employee performance evaluation process as the performance data is in terms of a unit value.

1. A method of performance evaluation, comprising:
providing each employer from a plurality of employees with a user interface to view and access information using a client component;
assigning a key result area to each sub-ordinate employee from a plurality of sub-ordinate employees of a senior employee;
storing the assigned key result area in a first database of a context manager,
setting at least one objective against each key result area for each sub-ordinate employee from the plurality of sun-ordinate employees such that there is no doubt or misunderstanding as to a time within which an activity is to be completed;
providing a plurality of categories of virtual gifts in a server;
assigning a unit value to each category of virtual gifts based on importance and relevance;
using virtual gifts as a corollary to an employee's performance in the server;
storing the unit value to each category of virtual gifts in a second database;
linking each virtual gift with a predetermined unit value by the server;
enabling the senior employee to give one or more virtual gifts to any of the sub-ordinate employees from the plurality of sub-ordinate employees; and
calculating an appraisal based on a predetermined formula provided in the server to convert a total unit value for a sub-ordinate employee into a materialized reward.

2. The method as claimed in claim 1, wherein the client component is a communicating device.

3. The method as claimed in claim 1, wherein at least one virtual gift from the categories of virtual gifts is mapped to a key result area of a sub-ordinate employee.

4. The method as claimed in claim 1, wherein a given sub-ordinate employee is enabled to ask for a gift against a standard set of the given sub-ordinate employee's key result area.

5. The method as claimed in claim 4, wherein a request for a gift raised by the given subordinate employee is responded by the senior employee with an assignment that the given sub-ordinate employee needs to perform to earn the requested gift.

6. The method as claimed in claim 1, wherein respective key result areas of sub-ordinate employees are visualized through virtual gifts acquired.

7. The method as claimed in claim 1, wherein an appraisal cycle is made available to all the sub-ordinate employees in the plurality of sub-ordinate employees for continuous performance management.

8. The method as claimed in claim 1, further comprising:
enabling an entity to provide a mini intranet for the sub-ordinate employees to share important and relevant information;
providing the user interface to a given sub-ordinate employee from the plurality of sub-ordinate employees showcasing food related information, special achievements of the given sub-ordinate employee, announcements, birthdays, and anniversaries, thereby increasing interaction between the given sub-ordinate employee and the senior employee.

9. The method as claimed in claim 1, further comprising:
providing and enabling a given sub-ordinate employee from the plurality of sub-ordinate employees with the user interface to showcase a technical skill level or competency of the given sub-ordinate employee, the user interface further enabling the given sub-ordinate employee to adopt a technical profile and have followers; and
providing a symbolic book shelf with a number of books representing skills of the given sub-ordinate employee with competency or skill level, thereby showcasing employee skills and expertise in a given entity.

10. The method as claimed in claim 8, wherein the given sub-ordinate employee is further enabled to add follower.

11. The method as claimed in claim 8, wherein a visitor is able to follow the given sub-ordinate employee.

12. A system of performance evaluation, comprising:
a user interface provided to each sob-ordinate employee from a plurality of sub-ordinate employees to view and access information, the user interface enabling a sub-ordinate employee from the plurality of sub-ordinate employee access to a view model, which provides a data model and behavior, the user interface allowing a view to declaratively bind to the view model;
a first database configured to store at least one objective or key result area for a sub-ordinate employee from the plurality of sub-ordinate employees that is created and maintained for future reference;
a second database provided for repository wherein at a start of an appraisal cycle, a user is enabled to set up various categories of virtual gifts and assign a unit value to each gift category based on importance and relevance; and
a client component configured to communicate with a server to populate entities with data, and send the data to the server;
wherein the client component comprises views, a context manager class, and a service proxy helper class,
wherein the context manager class is configured to maintain a current context of an application, and comprises logged-in user data, current user data, or a list of gifts data,
wherein the server is configured to communicate with the client component and an entities component used at both a client side and a server side, and
wherein the server comprises an API Factory class utilities, and a data access layer.

13. The system as claimed in claim 12, wherein the user interface is provided on a communication device.

14. The system as claimed in claim 12, wherein the user interface is configured to enable viewing and accessing information with a look and feel varying as per grade or designation of a sub-ordinate employee from the plurality of sub-ordinate employee.

15. The system as claimed in claim 12, wherein the user interface themes are configured to be maintained and loaded on run-time after successful login.
